(19) United States
(12) Patent Application Publication
(10) Pub. No.: US 2023/0229717 A1
(43) Pub. Date: Jul. 20, 2023

(54) OPTIMIZED REAL-TIME STREAMING GRAPH QUERIES IN A DISTRIBUTED DIGITAL SECURITY SYSTEM

(71) Applicant: Crowdstrike, Inc., Sunnyvale, CA (US)

(72) Inventors: Hyacinth David Diehl, Minneapolis, MN (US); Michael Edward Lusignan, Lake Mary, FL (US); Brent Ryan Nash, Ladera Ranch, CA (US); Liudmila Nikolaeva, Newcastle, WA (US); Nora Lillian Sandler, Seattle, WA (US); Garry James Bodsworth, Longstanton (GB)

(21) Appl. No.: 17/576,734

(22) Filed: Jan. 14, 2022

(51) Int. Cl. G06F 16/9532; G06F 16/9536; H04L 9/40

(52) U.S. Cl. CPC G06F 16/9532; G06F 16/9536; H04L 63/1408

(57) ABSTRACT

An event query host can include one or more processors configured to process an event stream indicating events that occurred on one or more computing devices. The event stream comprises event data that is associated with occurrences of events on the one or more computing devices. The event query host can forward the event data to a first query engine and to a second query engine. The first query engine can determine, based on a set of query definitions, that the forwarded event data is associated with a first query to be executed by the first query engine, and so executes the first query instance associated with the first query. The second query engine can also determine, based on the set of query definitions, that the forwarded event data is associated with a second query to be executed by the second query engine, and so executes the second query instance associated with the second query.

### CROSS REFERENCE TO RELATED DOCUMENTS

This U.S. Pat. Application is related to U.S. Pat. Application No. 16/849,543, entitled “Distributed Digital Security System” filed Apr. 15, 2020, the disclosure of which is incorporated by reference herein in its entirety, and is related to U.S. Pat. Application No. 17/325,097, entitled “Real-Time Streaming Graph Queries” filed May 19, 2021, the disclosure of which is incorporated by reference herein in its entirety.

### TECHNICAL FIELD

Embodiments of the present invention relate to digital security systems, particularly with respect to executing queries by one or both of two different query engines about events detected on a computing system.

### BACKGROUND

Digital security exploits that steal or destroy resources, data, and private information on computing devices are an increasing problem. Governments and businesses devote significant resources to preventing intrusions and thefts related to such digital security exploits. Some of the threats posed by security exploits are of such significance that they are described as cyber terrorism or industrial espionage.

Security threats come in many forms, including computer viruses, worms, trojan horses, spyware, keystroke loggers, adware, and rootkits. Such security threats may be delivered in or through a variety of mechanisms, such as spearfish emails, clickable links, documents, executables, or archives. Other types of security threats may be posed by malicious users who gain access to a computer system and attempt to access, modify, or delete information without authorization.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a system in which an event query host can process an event stream associated with at least one computing device using one of two or both query execution engines.

FIG. 2 shows an example of an event graph.

FIG. 3 shows a flowchart of an example process for modifying an event graph, and adding query instances to a query queue, substantially in real-time based on an event stream.

FIG. 4 shows a flowchart of an example process for executing, at scheduled execution times, query instances in a query queue.

FIG. 5 depicts an example of a refinement operation that can be performed by an instance of a compute engine in a distributed security system.

FIG. 6 depicts an example of a composition operation that can be performed by an instance of a compute engine in a distributed security system.

FIG. 7 depicts a flowchart of operations that can be performed by an instance of a compute engine in a distributed security system.

FIG. 8 shows an event graph.

FIG. 9 shows a flowchart of an example process for modifying an event graph, and adding query instances to a query queue, substantially in real-time based on an event stream, and for executing query instances.

FIG. 10 shows an example system architecture for a computing system associated with an event query host.

### DETAILED DESCRIPTION

Events can occur on computer systems that may be indicative of security threats to those systems. Although in some cases a single event may be enough to trigger detection of a security threat, in other cases individual events may be innocuous on their own but be indicative of a security threat when considered in combination with other events. For instance, opening a file, copying file contents, and opening a network connection to an Internet Protocol (IP) address may each, on their own, be normal and/or routine events on a computing device. However, the particular combination of those events may indicate that a process executing on the computing device is attempting to steal information from a file and send it to a server.

Digital security systems have accordingly been developed that can observe events that occur on computing devices, and that can use event data about one or more event occurrences to detect and/or analyze security threats. However, many such digital security systems are limited in some ways.

For example, some digital security systems only execute locally on individual computing devices. While this can be useful in some cases, local-only digital security systems may miss broader patterns of events associated with security threats that occur across a larger set of computing devices. For instance, an attacker may hijack a set of computing devices and cause each one to perform events that are innocuous individually, but that cause harmful results on a network, server, or other entity when the events from multiple computing devices are combined. Local-only security systems may accordingly not be able to detect a broader pattern of events across multiple computing devices.

As another example, some digital security systems receive event data reported by local security agents executing on computing devices, but store event data associated with numerous computing devices at a cloud server or other centralized repository. Although such a centralized repository of event data may have the storage space to store a large amount of event data, it can be difficult and/or inefficient for other elements of the digital security system to interact with the event data in the centralized repository. For instance, an event analysis system may be configured to evaluate received event data to determine whether the event data matches patterns associated with malicious behavior. However, the event analysis system may have to use an application programming interface (API) to submit a query over a network to the separate centralized repository, and wait for the centralized repository to return a response to that query over the network. Such network-based interactions can introduce latencies, and thereby delay the event analysis system from determining that patterns of malicious behavior have occurred on a computing device. Such delays can be significant for digital security systems, as malicious processes may be able to continue operating and attack computing devices until digital security systems identify corresponding patterns of malicious behavior.

As another example, some digital security systems may execute a set of standing queries against a collection of received event data on a regular basis, such as every minute. However, if a pattern of malicious behavior includes a series of multiple events that may occur over a period of five minutes, it can be inefficient for a digital security system to attempt to find that pattern in received event data once per minute. For example, the first four attempts at executing a query for that pattern (executed at a first minute mark, a second minute mark, a third minute mark, and a fourth minute mark) may be unlikely to succeed, if the full pattern is generally not found for five minutes. In this situation, executing a particular query every minute, even though multiple initial attempts are unlikely to succeed, can waste processing cycles, increase load on a database that stores the event data, delay execution of other queries that may be more likely to succeed, and/or cause other inefficiencies.

In some digital security systems, it may also be difficult to determine which queries to execute, and at which times. For instance, a security system may be configured to execute a set of queries against a database of event data. The security system may not be able to execute all of the queries concurrently, and thus may need to select which query to execute when resources are available to execute a new query. However, many security systems do not execute queries in an order determined based at least in part on event data that has actually been received. For instance, some security system may execute queries from the set of queries in a random order, in a round-robin order, in a predefined order, or in other orders, without selecting those queries based on which ones may be most likely to succeed. As an example, a security system may, based on a round-robin execution order, execute a query for an external network connection event even though the security system has not received event data indicating that a computing device recently initiated an external network connection. This query may accordingly be unlikely to succeed.

Additionally, some digital security systems may repeat entire queries if the queries are not initially successful. For instance, if a full pattern of events associated with a query is not found during an initial execution of the query, some digital security systems may search again for the full pattern of events during the next execution of the query, even if a portion of the pattern had been found during the initial query. Accordingly, these digital security systems may have to keep data associated with the partial pattern that has already been found so that it can be found again, and it may take longer and/or use additional computing resources to search for the entire pattern again during the next execution of the query.

Described herein are systems and methods associated with a digital security system that can address these and other deficiencies of digital security systems. For example, an event query host in the digital security system can store, in local memory, an event graph that represents events and relationships between events. Accordingly, information in the event graph can be locally-accessible by elements or components of the event query host. An event processor of the event query host can add representations of events and relationships between events that occurred on a computing device to the event graph, substantially in real-time as information about the events and their corresponding relationships, i.e., event data, is received by the event query host. The event processor can then forward the event information to different local query execution engines (“query engines”). Alternatively, the different query engines can receive notification of event information as it is received and/or as event data is added to the event graph, and access the event data directly from the graph.

If an event added to the event graph matches a trigger event for a query to be executed by a first one of the different query engines (“the first query engine”, or “query manager”), the event processor can add a corresponding query instance to a query queue, to be executed at a scheduled execution time by the first query engine. If the event added to the event graph matches a trigger event for another query to be executed by a second one of the different query engines (“the second query engine”, or “compute engine”), the event processor can add a corresponding query instance to a query queue, to be executed by the second query engine. Accordingly, query instances can be scheduled and executed at least in part due to corresponding event data that has actually been received by the event query host.

Additionally, at the scheduled execution time for a query instance to be executed by the first query engine (“query manager”), the query manager can search the local event graph for a corresponding event pattern. If a matching event pattern is not found in the local event graph, the query manager can reschedule the query instance in the query queue to be re-attempted at a particular later point in time when a matching event pattern is more likely to be in the event graph. The query manager may also store a partial query state associated with any matching portions of the event pattern that were found in the event graph, such that the query manager can avoid searching for the full event pattern again during the next execution of the query instance.

If the event added to the event graph matches a trigger event for the second query engine (“compute engine”), the event processor can add a corresponding query instance to a query queue, to be executed by the compute engine. As described further below, the compute engine can process event data about single events and/or patterns of events that occur on one or more computing devices. For example, the compute engine can perform comparisons, such as string match comparisons, value comparisons, hash comparisons, and/or other types of comparisons on event data for one or more events, and produce new event data based on results of the comparisons. For example, the compute engine can process event data in an event stream using refinements and/or compositions, as further discussed below.

### Event Query Host and Query Manager

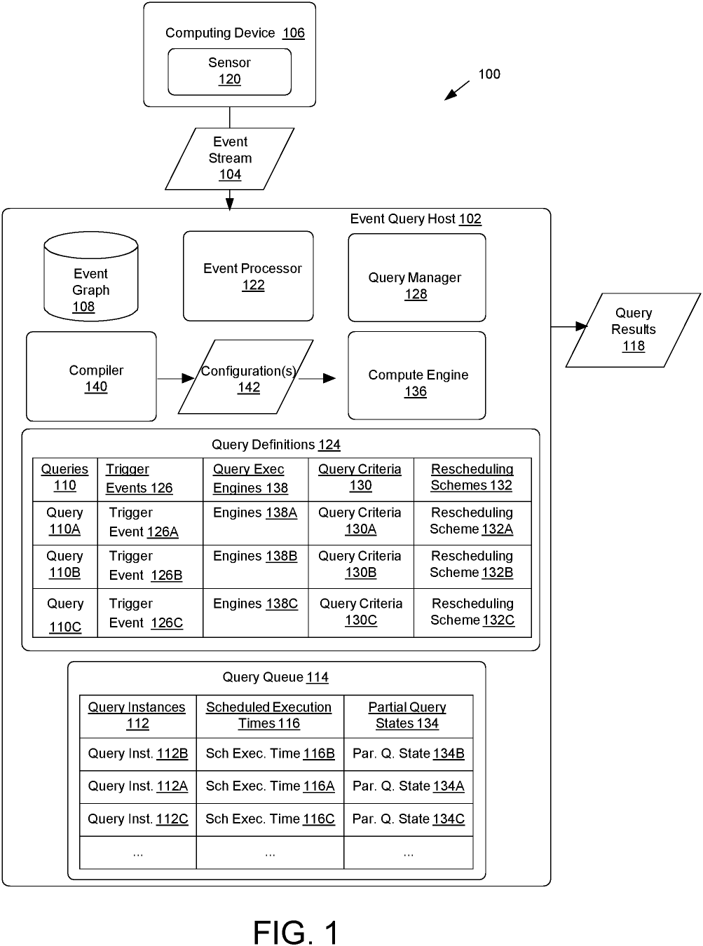

FIG. 1 shows an example 100 of a system in which an event query host 102 can process an event stream 104 associated with at least one computing device 106. The event stream 104 can include instances of event data associated with discrete events that occurred on the computing device 106. The event query host 102 can generate and maintain an event graph 108 based on the event stream 104. The event graph 108 can include vertices that represent events that occurred on the computing device 106, and edges between the vertices that represent relationships between the events. The event query host 102 can manage a set of queries 110, such as query 110A, query 110B, and query 110C, shown in FIG. 1.

The event query host 102 may also execute individual query instances 112, corresponding to one or more of the queries 110, against the event graph 108. The query instances 112 may be ordered within a query queue 114 according to scheduled execution times 116. The event query host 102 may accordingly execute individual query instances 112 in the query queue 114 at the scheduled execution times 116. If the event query host 102 finds matches for the query instances 112 in the event graph 108, the event query host 102 can output corresponding query results 118. If the event query host 102 does not find matches for a query instance in the event graph 108, the event query host 102 may reschedule the query instance within the query queue 114 based on a later scheduled execution time.

The computing device 106 may have at least one sensor 120 that is configured to detect the occurrence of events on the computing device 106. For example, the sensor 120 may be a security agent installed on the computing device 106 that is configured to monitor operations of the computing device 106, such as operations executed by an operating system and/or applications. The sensor 120 may be configured to detect when certain types of events occur on the computing device 106. The sensor 120 may also be configured to transmit the event stream 104, over the Internet and/or other data networks, to a remote security system that includes the event query host 102.

The event stream 104 may indicate information about multiple events on the computing device 106 that were detected by the sensor 120. Such events can include events and behaviors associated with software operations on the computing device 106, such as events associated with Internet Protocol (IP) connections, other network connections, Domain Name System (DNS) requests, operating system functions, file operations, registry changes, process executions, and/or any other type of operation. By way of non-limiting examples, an event may be that a process opened a file, that a process initiated a DNS request, that a process opened an outbound connection to a certain IP address, that there was an inbound IP connection, that values in an operating system registry were changed, or any other type of event. In some examples, events may also, or alternatively, be associated with hardware events or behaviors, such as virtual or physical hardware configuration changes or other hardware-based operations. By way of non-limiting examples, an event may be that a Universal Serial Bus (USB) memory stick or other USB device was inserted or removed, that a network cable was plugged in or unplugged, that a cabinet door or other component of the computing device 106 was opened or closed, or any other physical or hardware-related event.

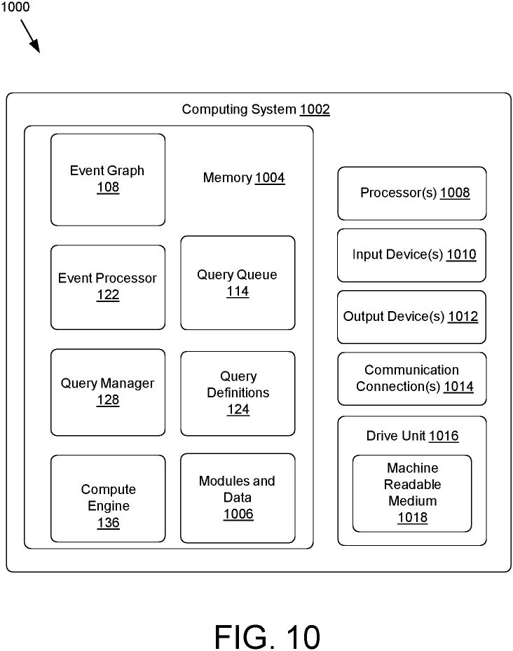

The event query host 102 can be part of a distributed digital security system, such as a system associated with a security service that operates remotely from the computing device 106. For example, the event query host 102 can be, or execute on, a computing system different from the computing device 106, such as the computing system described below with respect to FIG. 10. In some examples, the security system that includes the event query host 102 may process event streams associated with multiple computing devices. The event graph 108, generated from such event streams, may be associated with a single computing device or a group of computing devices. One or more event query hosts in the security system can use queries 110 to determine when events or patterns of events, associated with behavior of interest, have occurred on one or more of the computing devices. In some examples, the behavior of interest associated with a query may be malicious behavior, such as behavior that may occur when malware is executing on the computing device 106, when the computing device 106 is under attack by an adversary who is attempting to access or modify data on the computing device 106 without authorization, or when the computing device 106 is subject to any other security threat.

If the event query host 102 detects an occurrence of such an event or pattern of events, based on executing a query against the event graph 108 representing events that occurred on one or more computing devices, the event query host may output corresponding query results 118. For instance, the query results 118 may indicate that a pattern of events associated with malware, other malicious behavior, or any other behavior of interest has occurred on the computing device 106. Based on query results 118 generated by the event query host 102, the security system may log instances of the behavior of interest, provide the query results 118 and/or corresponding event data to data analysts or event analysis systems within the security system, provide the query results 118 and/or corresponding instructions to the sensor 120, and/or take other actions in response to the query results 118. For example, if the query results 118 indicate that the computing device 106 is under attack by a malicious process executing on the computing device 106, the security system may instruct the sensor 120 to block or terminate the malicious process, or to provide further information in the event stream 104 about ongoing activity of the malicious process.

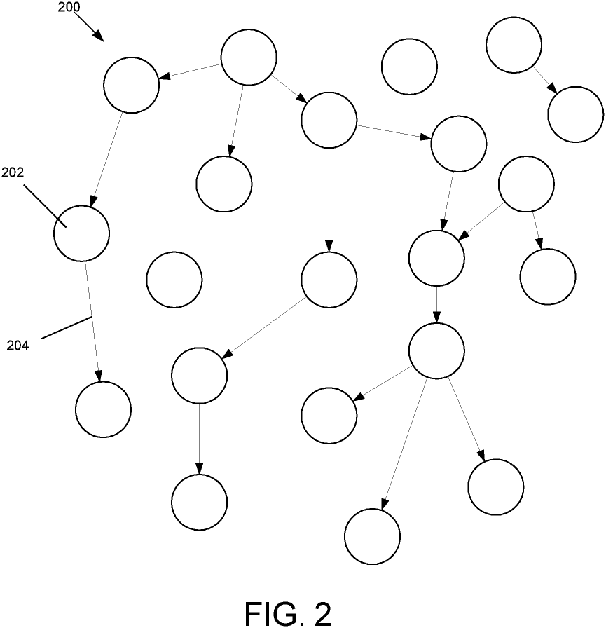

The event query host 102 can have an event processor 122 that is configured to modify the event graph 108 to add information about individual events that the event processor 122 identifies within the event stream 104, substantially in real-time as information about events are received in the event stream 104. Accordingly, the event graph 108 can be updated, substantially continuously and in real-time, to include information about a set of events that occurred on the computing device 106. For example, when the event processor 122 identifies an occurrence of a new event on the computing device 106 based on new information received in the event stream 104, the event processor 122 may add a new vertex to the event graph 108 that represents the new event. In some cases, the event processor 122 may also add or edit one or more edges in the event graph 108 that link the new vertex to one or more other vertices in the event graph 108, based on relationships determined by the event processor 122 between the events represented by the vertices. Data associated with the event graph 108 may be stored in a database at, or accessible by, the event query host 102, for example as discussed below with respect to FIG. 2.

In some examples, the event processor 122 may be configured with a set of event definitions. The event definitions may define data formats that the event processor 122 can use to identify and/or interpret event data within the event stream 104. For example, the sensor 120 may be configured to use a particular data format to provide event data about a particular type of event within the event stream 104, and the event processor 122 may also be configured to interpret the event data according to that particular data format. In some examples, the event definitions used by the event processor 122 and/or the sensor 120 may be changed or reconfigured over time. For example, event definitions associated with various event types can be changed or added to cause the sensor 120 to capture data about new types of events or to capture new or different data about known types of events, and the event processor 122 can accordingly also use such event definitions to interpret corresponding event data provided by the sensor 120 in the event stream 104.

In some examples, the event definitions used by the event processor 122 and/or the sensor 120 may be ontological definitions managed by an ontology service within the security service, as described in the incorporated by reference U.S. Pat. Application No. 16/849,543, entitled “Distributed Digital Security System”. For example, the event query host 102 may have an ontology manager (not shown) that is configured to receive ontological definition configurations from the ontology service, and provide ontological definitions of events to the event processor 122.

The event query host 102 may also be configured with a set of query definitions 124 associated with queries 110. The query definitions 124 may be configuration files, computer-executable instructions, and/or other data that indicate attributes of queries 110. In some examples, the event query host 102 may store the query definitions 124 in the same database as the event graph 108. In other examples, the event query host 102 may store the query definitions 124 in a different database or data structure.

The event query host 102 may also maintain the query queue 114, which can include an ordered representation of query instances 112. The query queue 114 may be ordered or sorted, for example, based on scheduled execution times 116 associated with the query instances 112. In some examples, the event query host 102 may store data associated with the query queue 114 in the same database as the event graph 108 and/or the query definitions 124. In other examples, the event query host 102 may store the data associated with the query queue 114 in a different database or data structure.

Each query instance in the query queue 114 may be associated with a corresponding query, and have the attributes of that query defined by the query definitions 124. For example, the query queue 114 may include any number of distinct query instances 112 corresponding to query 110A, as well as any number of distinct query instances 112 corresponding to queries 110B and 110C. Query instances 112A corresponding to query 110A may be distinct instances of query 110A, and/or have the attributes of query 110A. Similarly, query instances 112B corresponding to query 110B may be distinct instances of query 110B, and/or have the attributes of query 110B. Likewise, query instances 112C corresponding to query 110C may be distinct instances of query 110C, and/or have the attributes of query 110C.

At any point in time, the query queue 114 may or may not include query instances 112 that correspond to all of the queries 110 managed by the event query host 102. For example, the query queue 114 may not include a query instance that corresponds to query 110A at a first point in time, but the query queue 114 may include one or more query instances 112A that correspond to query 110A at a second point in time.

The queries 110 may be associated with corresponding trigger events 126. For example, query 110A may be associated with trigger event 126A, while query 110B may be associated with trigger event 126B, and query 110C may be associated with trigger event 126C. The trigger event for a query may be a particular type of event, that if detected in the event stream 104, may indicate that the event query host 102 should execute an instance of the query against the event graph 108.

Accordingly, the event processor 122 may be configured to detect trigger events 126, associated with the queries 110, in the incoming event stream 104. If the event processor 122 detects a trigger event associated with a particular query in the event stream 104, the event processor 122 can add a new query instance to the query queue 114 that corresponds to that particular query. For example, as the event processor 122 is identifying events in the event stream 104 in order to add information associated with such events to the event graph 108, the event processor 122 may determine that one of the events is the trigger event 126A for query 110A. The event processor 122 may add information associated with the event to the event graph 108, and also add a new query instance to the query queue 114 that corresponds with query 110A.

The queries 110 may be further associated with corresponding instances of query execution engines 138, for example, query manager 128 and/or compute engine 136. For example, the query definition 124 for query 110A may be associated with an instance of query execution engine(s) 138A, while the query definition 124 for query 110B may be associated with an instance of query execution engine(s) 138B, and the query definition 124 for query 110C may be associated with an instance of query execution engine(s) 138C. The instances of query execution engine(s) identified in a query definition 124 for a query 110 may be a particular query execution engine (e.g., query manager 128 or compute engine 136), or multiple query execution engines (e.g., query manager 128 and compute engine 136) that, when the associated trigger event 126 for the query is detected in the event stream 104, the respective query execution engine(s)is(are) to execute at least a portion of an instance of the query against the event graph 108. For example, the instance of query execution engine 138A associated with query 110A may be query manager 128, while the instance of query execution engine 138B associated with query 110B may be compute engine 136, and the instance of query execution engine 138C associated with query 110C may be both query manager 128 and compute engine 136.

Accordingly, one or more query execution engines may be configured to detect trigger events 126, associated with the queries 110, in the incoming event stream 104. If a query execution engine 138 detects a trigger event 126 associated with a particular query 110 in the event stream 104, the query execution engine 138 can add a new query instance 112 to the query queue 114 that corresponds to that particular query 110. For example, as the event processor 122 is identifying events in the event stream 104 in order to add the information associated with such events to the event graph 108, a query execution engine 138A may determine that one of the events is the trigger event 126A for query 110A that the query execution engine 138A is to execute. The event processor 122 may add information associated with the event to the event graph 108, and also add a new query instance to the query queue 114 that corresponds with query 110A. Alternatively, the query execution engine 138A may add the new query instance to the query queue 114 that corresponds with query 110A that the query execution engine 138A is to execute.

In some examples, a trigger event for a query may be associated with an event type, as well as one of more filters that, if satisfied, indicate that a corresponding query instance should be added to the query queue 114. Filters may indicate a minimum version requirement for an event, a requirement that a particular data field associated with the event includes a particular value, a requirement that an identifier of the event be included on a whitelist store by the event query host, and/or any other requirement. The event processor 122 may accordingly identify one or more candidate events in the event stream 104 that may be a trigger event for a query, and then use one or more filters associated with the query to determine if the candidate events are actually trigger events 126 for the query. If such an event satisfies the filters associated with a query, and is therefore a trigger event associated with the query, the event processor may add a corresponding query instance to the query queue 114.

As a non-limiting example, a trigger event for a query may have a DNS lookup event type, but be associated with one or more filters for DNS lookups of particular domain names, or that return specific IP addresses or an IP address in a particular range of IP addresses. The event processor 122 may accordingly identify all DNS lookup events in the event stream 104 as potential trigger events, and use corresponding filters to determine if any of those DNS lookup events satisfy the filters and are to be treated as actual trigger events 126.

In some examples, the event processor 122 may be configured to perform de-duplication operations on received event data. For example, multiple instances of the same event data may arrive at different times in the event stream 104. The event processor 122 may be configured to determine whether an instance of received event data has already been added to the event graph 108 and/or matched a trigger event such that the instance of event data already prompted the event processor 122 to add a query instance to the query queue 114. In these examples, if the event processor 122 determines that an instance of received event data is a duplicate of a previously-received instance of event data, the event processor 122 may avoid adding another representation of the duplicated instance of event data to the event graph 108, and may also avoid adding another query instance to the query queue 114 based on the duplicated instance of event data.

In some examples, the event processor 122 may add new query instances 112 to the query queue 114 with scheduled execution times 116 that are selected based on a default scheduling configuration. For example, the event processor 122 may be configured to add a new query instance to the end of the query queue 114 by assigning the new query instance a scheduled execution time that is at least a predefined amount of time later than the scheduled execution time of the last query instance already present within the query queue 114.

As a non-limiting example, the query queue 114 may contain query instance 112A and query instance 112B. The query instance 112A may be the lowest-priority query instance in the query queue 114, because the scheduled execution time 116A of query instance 112A is later than the scheduled execution time 116B of query instance 112B. The event processor 122 may be configured to add new query instance 112C at the end of the query queue 114 with a scheduled execution time 116C that is later than scheduled execution time 116A of query instance 112A.

In other examples, the event processor 122 may be configured to assign a new query instance a scheduled execution time that causes the new query instance to be placed at the front or middle of the query queue 114. As a non-limiting example, if a particular query has a high importance or priority level, and the event processor 122 detects a trigger event associated with that query, the event processor 122 may add a new corresponding query instance to the query queue 114 with a scheduled execution time that causes the new query instance to be executed before other query instances 112 already present in the query queue 114.

Some or all of the queries 110 may be standing queries that can lead to corresponding query instances 112 being added to the query queue 114 at any time. However, in some examples, the query definitions 124 may indicate that one or more of the queries 110 are ephemeral queries. Ephemeral queries may be associated with specific periods of time, specific sensors, specific events in the event stream, or other specific conditions. As an example, an ephemeral query may indicate that all of the event data from a particular sensor, such as sensor 120, should be examined using specific query criteria 130 for a period of ten minutes. Accordingly, corresponding query instances may be active in the query queue 114 for up to ten minutes. As another example, an ephemeral query may indicate that if a particular process is launched on the computing device 106, all related events associated with that particular process and/or any of its child processes should be monitored according to specific query criteria 130 until the particular process terminates. Accordingly, corresponding query instances may be active in the query queue 114 until event data is received in the event stream indicating that the particular process has terminated.

In some examples, the event query host 102 may be associated with a user interface and/or API that allows users, or an application program, to view query definitions 124, edit query definitions 124, delete query definitions 124, and/or add new query definitions 124, including viewing, editing, deleting or adding trigger events for query definitions, or viewing, editing, deleting or adding query execution engine(s) to handle particular query instances corresponding to query definitions. For example, a user may generate a definition for a new type of query, and use the API to submit the new query definition to the event query host 102 as a new standing query or an ephemeral query. In some examples, the user may generate the definitions according to an intermediate language, which are then translated by event query host 102 or event processor 122 into a machine language used by a query execution engine. In some examples, the different query execution engines use different machine languages, so the event query host 102 or event processor 122 may translate the user generated query definitions from the intermediate language into the respective machine languages used by the different query execution engines.

In some examples, the user interface and/or API may be associated with a centralized computing device or service that can generate and manage query definitions 124 and periodically provide updates to the query definitions 124 to the event query host 102 and/or other event query hosts. In other examples in which multiple event query hosts are associated with each other, updates to query definitions 124 made locally at the event query host 102 may be propagated to the other event query hosts over a network connection. The centralized computing device, and/or each event query host, may have a database that stores information about changes to the query definitions 124 over time, for example for backup and/or auditing purposes.

As mentioned above, the event query host 102 can have a query execution engine, such as the query manager 128, that is configured to manage and execute query instances 112 in the query queue 114, based on corresponding scheduled execution times 116. The query queue 114 may be ordered based on the scheduled execution times 116 of the query instances 112, such that the query manager 128 can attempt to process the highest-priority query instance in the query queue 114 at the scheduled execution time of that query instance. For example, query instance 112B shown in FIG. 1 may be the highest-priority query instance in the query queue 114, if the scheduled execution time 116B is earlier than the scheduled execution times 116 of other query instances 112 in the query queue 114.

The queries 110, and thus corresponding query instances 112 in the query queue 114, may be associated with query criteria 130. For example, query 110A may be associated with query criteria 130A, while query 110B may be associated with query criteria 130B, and query 110C may be associated with query criteria 130C. Query criteria 130 for the queries 110 may indicate that the queries 110 are filter queries, metadata queries, or pattern queries.

In some examples, the query criteria 130 for a query may be a pattern of one or more events that is expressed using a graph representation that represents the events as vertices, and uses edges between the vertices to represent relationships between the events. A query may accordingly be satisfied if at least one sub-graph that matches the graph associated with the query criteria 130 for the query is found within the event graph 108.

At the scheduled execution time of a query instance in the query queue 114, a query execution engine such as the query manager 128 may determine the query criteria 130 of that query instance. The query manager 128 may also attempt to find a sub-graph, within the event graph 108, that matches a pattern indicated by the query criteria 130. For example, the query manager 128 may use graph isomorphism principles and/or perform graph traversal operations to search for one or more sub-graphs, within the event graph 108, that match a graph of events associated with a query instance.

If the query manager 128 executes a query instance in the query queue 114, and finds a sub-graph within the event graph 108 that matches the query criteria 130 of that query instance, the query instance may be satisfied. The query manager 128 may remove the query instance from the query queue 114, and cause the event query host 102 to generate corresponding query results 118.

However, if the query manager 128 executes a query instance in the query queue 114, but does not find a sub-graph within the event graph 108 that matches the query criteria 130 of that query instance, the query manager 128 may reschedule the query instance in the query queue 114. For example, the query manager 128 may edit the scheduled execution time of the query instance in the query queue 114, such that the query instance is lowered in the query queue 114 and is scheduled to be retried at a later time. Alternatively, the query manager 128 may drop the query instance from the query queue 114 if, after some number of attempts, the query manager does not find the sub-graph within the event graph 108 that matches the query criteria 130 of the query instance. According to yet another alternative, the query manager 128 may emit partial results generated by the query instance in the query queue 114 if, after some number of attempts, the query instance finds a portion of a sub-graph within the event graph 108 that matches some but not all of the query criteria 130 of the query instance.

As a non-limiting example, the query manager 128 may have previously executed query instance 112A, but not found a matching sub-graph in the event graph 108. The query manager 128 may have changed the scheduled execution time 116A of query instance 112A to a time that is later than the scheduled execution time of 116B of query instance 112B, in order to reschedule the next execution of query instance 112A after the next execution of query instance 112B.

The queries 110, and thus corresponding query instances 112 in the query queue 114, may be associated with rescheduling schemes 132. For example, query 110A may be associated with rescheduling scheme 132A, while query 110B may be associated with rescheduling scheme 132B, and query 110C may be associated with rescheduling scheme 132C. The rescheduling scheme for a query may indicate a wait time, or other rescheduling information, which the query manager 128 can use to determine a new scheduled execution time for a query instance corresponding to that query. For example, if the query manager 128 executes a query instance, but the query instance is not satisfied, the query manager 128 may reschedule the query instance in the query queue 114 to be executed again three minutes later, based on a rescheduling scheme that indicates a three-minute wait time. As a non-limiting example, query instance 112A shown in FIG. 1 may have been rescheduled after an earlier attempt, such that query instance 112B is a higher priority, and has an earlier scheduled execution time 116A, in the query queue 114 than query instance 112A.

In addition to scheduled execution times 116, the query instances 112 in the query queue 114 may be associated with partial query states 134. As discussed above, a query execution engine, such as the query manager 128, may execute a query instance at a corresponding scheduled execution time. The query manager 128 may identify query criteria 130 associated with the query instance, such as a graph that uses vertices and edges to represent a pattern of events and relationships between the events. The query manager 128 can accordingly attempt to find a sub-graph, within the event graph 108, that matches the graph associated with the query instance. If the query manager 128 does not find a full matching sub-graph within the event graph 108, but does find one or more matching portions of the sub-graph within the event graph 108, the query manager 128 may store data associated with the matching portions of the sub-graph as a partial query state associated with the query instance.

Although the partial query state can be stored in association with the query instance, the query instance may not yet be successful because the full query criteria 130 associated with the query instance has not yet been found in the event graph 108. The query manager 128 may accordingly reschedule the unsuccessful query instance in the query queue 114 with a later scheduled execution time, as discussed above. However, during the next execution of the query instance at the later scheduled execution time, the query manager 128 may use the stored partial query state to determine which portions of the query criteria 130 have already been found in the event graph 108. The query manager 128 can accordingly attempt to identify only the remaining portions of the query criteria 130 that have not yet been found in the event graph 108, instead of searching for the entire query criteria 130 in the event graph 108. For instance, the query manager 128 may search for remaining elements of a sub-graph associated with the query instance which, in combination with the stored partial query state, complete the full sub-graph. Accordingly, the partial query states 134 can allow the query manager 128 to pick up where it left off with respect to individual query instances 112 that are attempted more than once.

As a non-limiting example, query criteria 130 for query instance 112A may indicate a specific pattern of six events. Upon a first execution of query instance 112A, the query manager 128 may identify vertices and edges in the event graph 108 may match two of the six events associated with the query criteria 130 for query instance 112A. The query manager 128 may store a partial query state 134A in association with query instance 112A, and change the scheduled execution time 116A of query instance 112A in the query queue 114 so that the query manager 128 will execute query instance 112A again five minutes later. When the query manager 128 executes query instance 112A again five minutes later, the query manager 128 can determine from the stored partial query state 134A that two of the six events associated with the query criteria 130 for query instance 112A were already found in the event graph 108. The query manager 128 can accordingly attempt to find vertices and edges in the event graph 108 that match the remaining four events associated with the query criteria 130 for query instance 112A, rather than searching again for the full pattern of six events.

The partial query states 134 therefore allow the query manager 128 to continue searching for remaining elements of query criteria 130 associated with repeated query instances 112 that have not yet been found in the event graph 108, rather than searching for the full query criteria 130 in part by searching again for elements that have already been found. Accordingly, the query manager 128 can use the partial query states 134 (e.g., 134A, 134B, 134C) to efficiently search for the remaining elements of query criteria 130, and thereby avoid using processor cycles, memory, and other computing resources to search again for elements of query criteria 130 that have already been found in the event graph 108.

Moreover, the query manager 128 may determine, based in part on the partial query states 134, that the query criteria 130 for a query instance has been found in the event graph 108, even if some of the elements of the query criteria 130 have been deleted from the event graph 108. For example, during a first execution of query instance 112C, the query manager 128 may find a first vertex in the event graph 108 that matches a first portion of the query criteria 130 associated with the query instance 112C, and may store information about the first vertex in the partial query state 134C in association with the query instance 112C. Later, during a subsequent execution of query instance 112C, the query manager 128 may find other vertices and/or edges in the event graph 108 that, in combination with the first vertex, satisfy the query criteria 130 associated with the query instance 112C. In some situations, the first vertex may have been deleted from the event graph 108 after the first execution of query instance, for example based on a timestamp of the first vertex exceeding a time-to-live (TTL) value as will be discussed further below. However, because information associated with the first vertex had been stored in the partial query state 134C associated with query instance 112C, the information in the partial query state 134C may allow the query criteria associated with query instance 112C to be satisfied even if the first vertex is no longer present in the event graph 108.

As discussed above, the event processor 122 may be configured to receive the event stream 104, and add representations of identified events to the event graph 108, The event processor, or a query execution engine, such as query manager 128, can add new query instances 112 to the query queue 114 if identified events match trigger events 126 for queries 110. The query manager 128 may be configured to execute individual query instances 112 in the query queue 114 at scheduled execution times 116. The query manager 128 can also be configured to emit query results 118 if the query instances 112 are satisfied, or to store partial query states 134 and reschedule the query instances 112 within the query queue 114 if the query instances 112 are not yet satisfied. In some examples, the event processor 122 and the query executions engines, including the query manager 128 and compute engine 136, may execute substantially concurrently on a computing system. For instance, the computing system may execute operations of the event processor 122 using a first set of parallel threads, while substantially concurrently executing operations of the query manager 128 using a second set of parallel threads, and further substantially concurrently executing operations of the compute engine 136 using a third set of parallel threads. Accordingly, the event processor 122 may modify the event graph 108 based on new event data substantially in real-time, while the query manager 128 and compute engine 136 may execute query instances 112 against up-to-date event data in the event graph 108 as soon as the event data is received and added to the event graph 108 by the event processor 122.

Overall, the event query host 102 shown in FIG. 1 can locally store the event graph 108 of event data, such that query instances for event patterns can be locally executed against the event graph 108 without latencies that may be introduced by network-based queries to a remote database of event data. Moreover, the local event graph 108 can be modified substantially in real-time as new event data is received, and such modifications to the local event graph 108 may trigger new query instances 112 to be scheduled that are associated with the newly received event data. Accordingly, because the query instances 112 are scheduled based on recently received event data, such query instances 112 may be more likely to succeed. Additionally, the event query host 102 shown in FIG. 1 can dynamically schedule, and reschedule, individual query instances 112 based on historically-determined metrics about how long it may take to satisfy the query instances 112, and thereby avoid repeated query attempts at earlier times that may be unlikely to succeed. The event query host 102 shown in FIG. 1 can also store partial query states 134 associated with individual query instances 112 that have not yet been satisfied. Accordingly, during a later execution of a rescheduled query instance, a partial query state can be used to identify portions of an event pattern that have already been found in the event graph 108, and a search can be performed for remaining portions of the event pattern instead of a new search for the entire event pattern. The partial query states 134 may accordingly lower search times associated with subsequent executions of query instances 112, reduce load on a database that stores the event graph 108, and query instances 112 to succeed even if matching event data is removed from the event graph 108.

FIG. 2 show an example 200 of the event graph 108. The event graph 108 can include vertices 202 that each represent an event that occurred on the computing device 106. The event processor 122 can be configured to, substantially in real-time upon identifying an event in the incoming event stream 104, add a vertex to the event graph 108 that represents information about the event. As a non-limiting example, if the event stream 104 indicates that a “RunDLL32.exe” process was executed on the computing device 106 at a certain time, the event processor 122 can add a vertex to the event graph 108 that identifies the “RunDLL32.exe” process, the time the “RunDLL32.exe” process was executed, and/or any other information about the “RunDLL32.exe” process indicated by the event stream 104.

Vertices 202 may also be connected by edges 204 in the event graph 108. The edges 204 can represent relationships between events represented by the vertices 202. For example, if the event stream 104 indicates that the “RunDLL32.exe” process discussed above spawned a “cmd.exe” process as a child process, the event processor 122 can add a vertex to the event graph 108 that represents the “cmd.exe” process, and add an edge between the vertex associated with the “RunDLL32.exe” process and the edge associated with the “cmd.exe” process. The edge between these two vertices 202 can indicate that the “RunDLL32.exe” process spawned the “cmd.exe” process.

In some examples, the event graph 108 can be a directed graph. For instance, an edge, between a first vertex representing a parent process and a second vertex representing a child process, can be a directional edge that points from the first vertex to the second vertex to represent the parent-child relationship between the processes.

Data defining entities within the event graph 108, such as the vertices 202 and the edges 204, can be stored in a database. For example, data associated with the event graph 108 may be stored in “RocksDB” database, or other type of database. The database may store key-value data for each entity, and information about different entities in the event graph 108 can be stored in the database using an adjacently list graph representation.

In some examples, the database storing the event graph 108 may be in local memory at the event query host 102, rather than being stored on a remote server or in a cloud computing environment. As such, the event processor 122 can add data to the event graph 108 in local memory substantially in real-time as events are identified in the event stream, without transmitting instructions over a data network to add the data to the event graph 108. Similarly, the query manager 128 can execute query instances 112 and perform graph traversal operations on the locally-stored event graph 108, rather than transmitting query instructions over a data network to a remotely-stored event graph 108 and waiting for results to be received over the data network. Accordingly, storing data associated with the event graph 108 in local memory at the event query host 102 can avoid latencies associated with data transmissions over data networks, and thereby can allow the event graph 108 to be updated and searched by elements of the event query host 102 more quickly. Local memory includes, for example, computing system memory such as a non-volatile memory express (NVMe) disk configured to store the event graph 108, in addition to the query definitions 124, the query queue 114, and/or other data associated with the event query host 102.

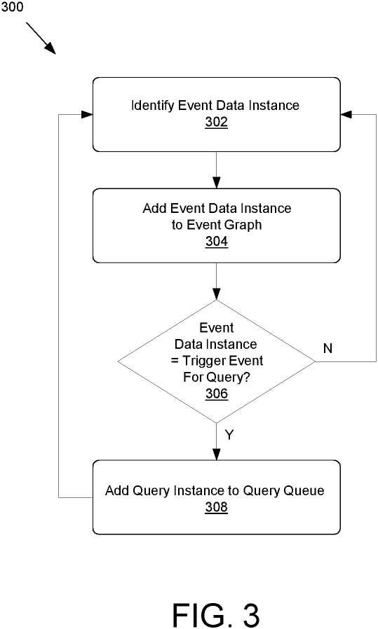

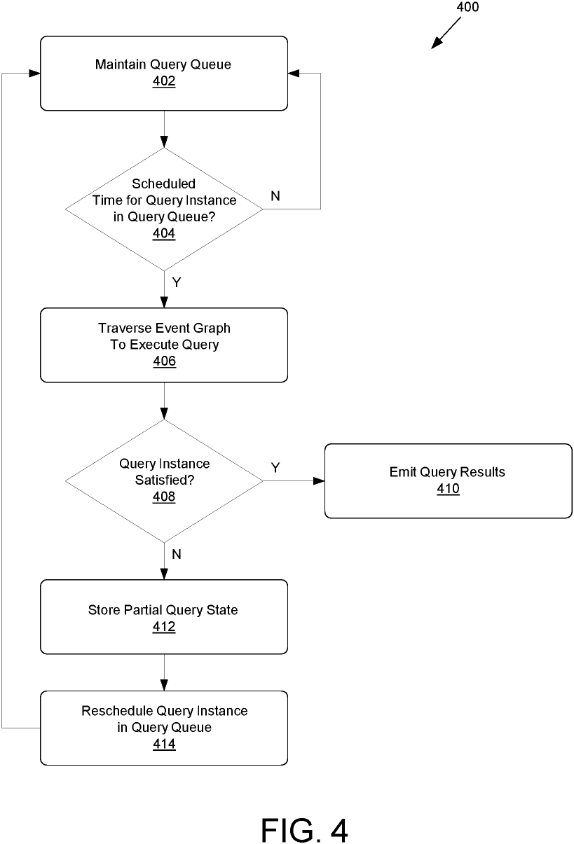

One or more event query hosts can execute processes associated with the event processor 122 and the query manager 128. Examples of such processes are shown and described with respect to FIG. 3 and FIG. 4.

FIG. 3 shows a flowchart of an example process 300 for modifying the event graph 108, and adding query instances to the query queue 114, substantially in real-time based on the event stream 104. The example process 300 shown in FIG. 3 may be performed by a computing system that executes the event processor 122 in conjunction with query manager 128 as part of the event query host 102, such as the computing system shown and described with respect to FIG. 10.

At block 302, the event processor 122 can identify an event data instance. For example, the event processor 122 may identify an event data instance within the event stream 104 received by the event query host 102. As discussed above, the event stream 104 can be a data stream that indicates events, detected by the sensor 120, that have occurred on the computing device 106. Accordingly, at block 302, the event processor 122 can identify an individual instance of event data indicated by information within the event stream 104. In some examples, the event processor 122 may receive event streams, associated with multiple computing devices and sensors, within a shard topic, as further discussed in incorporated by reference U.S. Pat. Application No. 17/325,097, entitled “Real-Time Streaming Graph Queries”. The event processor 122 may accordingly identify an event data instance, associated with one of those computing devices, within the shard topic at block 302. Alternatively, or in addition to sensor 120 detecting events that have occurred on computing device 106, the event stream 104 can include events detected by, for example, Cloud Security Posture Management (CSPM) security tools (not shown in FIG. 1) that have occurred in a cloud services computing environment of the security system customer. The event processor 122 may accordingly identify an event data instance associated with a computing device in the cloud services computing environment at block 302. Other sources of event data are also contemplated, such as, for example, identity protection data from active directory monitoring, event logs from network firewall devices, etc.

At block 304, the event processor 122 can add one or more entities to the event graph 108 that are associated with the event data instance identified at block 302. For example, the event processor 122 can add a vertex to the event graph 108 that represents the event data instance, and/or add an one or more edges to the event graph 108 that represents a relationship between events represented vertices 202 in the event graph 108. If no relationship exists between events represented vertices 202 in the event graph, no edge will be added to the event graph 108 between those vertices. The event processor 122 may add an entity to the event graph 108 at block 304 by adding an entry to a database, as discussed above with respect to FIG. 3.

At block 306, the event processor 122 or query manager 128, as the case may be, can determine whether the event data instance is a trigger event associated with a query. As discussed above, the event query host 102 can be configured with query definitions 124 for one or more queries 110, including indications of trigger events 126 for the queries 110. The event processor 122 and query manager 128 can accordingly use the query definitions 124 to determine whether the event data instance, identified at block 302, matches a trigger event for a query. A trigger event for a query may be associated with an event type, and/or one of more filters, as discussed above. In some examples, at block 306, the event processor 122 presents the query definitions to query manager 128 so query manager can determine whether the event data instance is a trigger event associated with a query. As discussed above, the event query host 102 can be configured with query definitions 124 for one or more queries 110, including indications of trigger events 126 for the queries 110. The query manager 128 can accordingly use the query definitions 124 to determine whether the event data instance, identified at block 302, matches a trigger event for a query. A trigger event for a query may be associated with an event type, and/or one of more filters, as discussed above.

If the event data instance identified at block 302 does not match a trigger event for any of the queries (Block 306 - No), the process can return to block 302, after adding a representation of the event data instance to the event graph 108, and process a subsequent instance of event data within the event stream 104. However, if the event data instance identified at block 302 does match a trigger event for a query (Block 306 - Yes), the event processor 122 or query manager 128 can add a corresponding query instance to the query queue 114. The event processor 122 or query manager may add the new query instance to the query queue 114 with a scheduled execution time selected based on a default scheduling configuration, based on a rescheduling scheme associated with the query, or based on any other scheduling configuration. The process can then return to block 302, and process a subsequent instance of event data within the event stream 104.

Overall, as shown in FIG. 3, the event processor 122 may add a representation of each identified event data instance, substantially in real-time as the event data is received and processed by the event processor 122. The event processor 122 or query manager 128 may also, substantially in real-time as the event data is received and processed by the event processor 122, add query instances 112 to the query queue 114 that are associated with event data instances that correspond to trigger events for queries 110, but avoid adding query instances 112 to the query queue 114 that are associated with instances of event data that do not correspond to trigger events 126 for queries 110. Accordingly, the query instances 112 that are scheduled within the query queue 114 by the event processor 122 or query manager 128 at block 308 can be likely to be at least partially satisfied when executed by the query manager 128, because event data corresponding to trigger events 126 for those query instances 112 was added to the event graph 108 at block 304.

FIG. 4 shows a flowchart of an example process 400 for executing, at scheduled execution times 116, query instances 112 in the query queue 114. The example process 400 shown in FIG. 4 may be performed by a computing system that executes the query manager 128 as part of the event query host 102, such as the computing device shown and described with respect to FIG. 10.

At block 402, the query manager 128 may maintain the query queue 114. As discussed above, the query queue 114 may be an ordered list or database of query instances 112 sorted by scheduled execution times 116. For example, the highest-priority query instance in the query queue 114 may be the query instance with the next scheduled execution time.

At block 404, the query manager 128 can determine if it is the scheduled execution time for a query instance in the query queue 114. For example, if it is not yet the scheduled execution time for the highest-priority query instance in the query queue 114, the query manager 128 can continue to maintain the query queue 114 at block 402 until the scheduled execution time for the highest-priority query instance in the query queue 114.

At the scheduled execution time for a query instance in the query queue, the query manager 128 may execute the query instance at block 406 by traversing the event graph 108 and searching for one or more entities in the event graph 108 that correspond with the query criteria 130 of the query instance. The query criteria 130 may be a pattern of one or more events, for instance as described above with respect to the example shown in FIG. 4. As a non- limiting example, at block 406 the query manager 128 can use graph isomorphism principles and/or perform graph traversal operations to search for one or more sub-graphs, within the event graph 108, that match a graph of events associated with the query instance.

In some examples, if the query instance is associated with a partial query state that indicates portions of the query criteria 130 previously found in the event graph 108, the query manager 128 may avoid searching the event graph 108 for the previously found portions of the query criteria 130. The query manager 128 may instead attempt to locate other portions of the query criteria 130 that have not yet been found in the event graph 108, but would satisfy the query criteria 130 in combination with the partial query state.

At block 408, the query manager 128 can determine if the query instance has been satisfied. For example, query manager 128 can determine if all of the elements of the query criteria 130 associated with the query instance have been found in the event graph 108, either based on the search performed at block 406 and/or in combination with a prior partial query state associated with the query instance. If all of the elements of the query criteria 130 associated with the query instance have been found in the event graph 108, the query manager 128 can determine if the query instance has been satisfied (Block 408 - Yes) and can output corresponding query results 118 at block 410.

However, if the query manager 128 determine that the query instance has not yet been satisfied (Block 408 - No), the query manager 128 may store the partial query state associated with the query instance. For example, if one or more portions of the query criteria 130 were found in the event graph 108 during the search performed at block 406, the query manager 128 may store those portions as a new partial query state block 412 associated with the query instance, or add the newly located portions to a previously-stored partial query state block 412 associated with the query instance, or end the query instance and emit partial query results at block 410.

At block 414, the query manager 128 can reschedule the query instance within the query queue 114, based on the rescheduling scheme associated with the query instance. For instance, if the query instance is associated with query 110A shown in FIG. 1, the rescheduling scheme 132A may indicate that 99% of the query instances associated with query 110A have historically been satisfied within the event graph 108 within five minutes. Accordingly, in some examples, the query manager 128 can be configured to adjust the scheduled execution time of the query instance such that the query instance is scheduled to be re-executed five minutes from the current time, or is scheduled to be re-executed during a window of time surrounding five minutes from the current time. In other examples, the query manager 128 can be configured to reschedule the query instance to be re-executed five minutes, or within a window of time surrounding the five-minute mark, after the query instance was initially added to the query queue 114.

The query manager 128 can, after rescheduling the query instance at block 414, return to block 402 and 404 to determine when it is the scheduled execution time for the next query instance in the query queue 114. The query manager 128 can accordingly execute query instances 112 in the query queue 114 at different execution times that are determined based on rescheduling schemes 132 associated with the query instances 112.

### Compute Engine

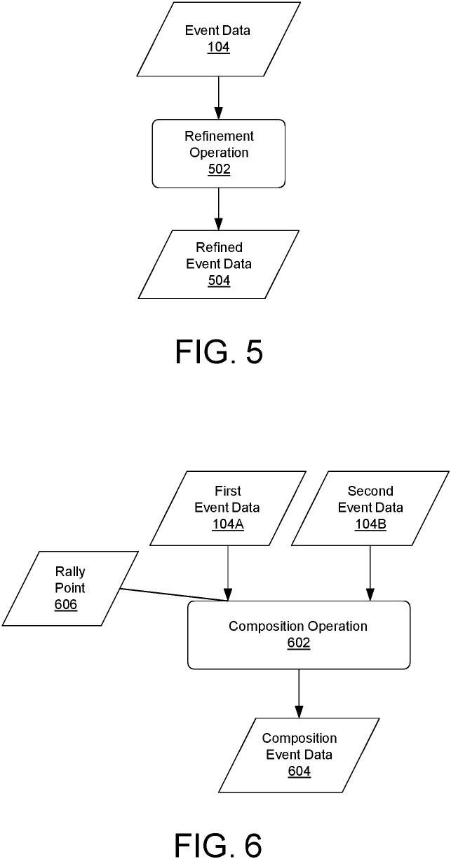

An instance of a query execution engine, such as compute engine 136, in event query host 102 can perform comparisons, such as string match comparisons, value comparisons, hash comparisons, and/or other types of comparisons on event stream 104 for one or more events, and produce new event data based on results of the comparisons. For example, an instance of the compute engine 136 can process event data in an event stream 104 using refinements and/or compositions of a fundamental model according to instructions created by compiler 140 and provided in a configuration 142. Refinement operations and composition operations that instances of the compute engine 136 can use are discussed below with respect to FIGS. 5-7.

FIG. 5 depicts an example of a refinement operation 502 that can be performed by an instance of the compute engine 136. A refinement operation 502 can have filter criteria that the compute engine 136 can use to identify event data from event stream 104 (hereinafter referred to simply as “event data 104”) to which the refinement operation 502 applies. For example, the filter criteria can define target attributes, values, and/or data elements that are to be present in event data 104 for the refinement operation 502 to be applicable to that event data 104. In some examples, filter criteria for a refinement operation 502 can indicate conditions associated with one or more fields of event data 104, such as the filter criteria is satisfied if a field holds an odd numerical value, if a field holds a value in a certain range of values, or if a field holds a text string matching a certain regular expression. When the compute engine 136 performs comparisons indicating that event data 104 matches the filter criteria for a particular refinement operation 502, the refinement operation 502 can create new refined event data 504 that includes at least a subset of data elements from the original event data 104.

For example, if the compute engine 136 is processing event data 104 as shown in FIG. 5, and the event data 104 includes data elements that match criteria for a particular refinement operation 502, the refinement operation 502 can create refined event data 504 that includes a least a subset of data elements selected from event data 104. In some examples, the data elements in the refined event data 504 can be selected from the original event stream 104 based on a context collection format. Context collections are discussed further in the incorporated by reference U.S. Pat. Application No. 16/849,543, entitled “Distributed Digital Security System”. A refinement operation 502 can accordingly result in a reduction or a down-selection of event data in an incoming event stream 104 to include refined event data 504 containing a subset of data elements from the event data.

As a non-limiting example, event data in an event stream 104 may indicate that a process was initiated on a computing device 106. A refinement operation 502 may, in this example, include filter criteria for a string comparison, hash comparison, or other type of comparison that can indicate creations of web browser processes. Accordingly, the refinement operation 502 can apply if such a comparison indicates that the created process was a web browser process. The compute engine 136 can accordingly extract data elements from the event data 104 indicating that the initiated process is a web browser, and include at least those data elements in newly generated refined event data 504.

In some examples, new refined event data 504 can be added to an event stream 104 as event data, such as the same and/or a different event stream that contained the original event data. Accordingly, other refinement operations 502 and/or composition operations 502 can operate on the original event data and/or the new refined event data from the event stream 104.

FIG. 6 depicts an example of a composition operation 602 that can be performed by an instance of the compute engine 136. A composition operation 602 can have criteria that the compute engine 136 can use to identify event data 104 to which the composition operation 602 applies. The criteria for a composition operation 602 can identify at least one common attribute that, if shared by two pieces of event data 104, indicates that the composition operation 602 applies to those two pieces of event data 104. For example, the criteria for a composition operation 602 can indicate that the composition operation 602 applies to two pieces of event data 104 when the two pieces of event data 104 are associated with child processes that have the same parent process.

The compute engine 136 can accordingly use comparison operations to determine when two pieces of event data from one or more event streams 104 meet criteria for a composition operation 602. When two pieces of event data meet the criteria for a composition operation 602, the composition operation 602 can generate new composition event data 604 that contains data elements extracted from both pieces of event data 104. In some examples, the data elements to be extracted from two pieces of event data 104 and used to create the new composition event data 604 can be based on a context collection format.

As an example, when first event data 104A and second event data 104B shown in FIG. 6 meet criteria of the composition operation 602, the composition event data 604 can be generated based on a context collection format to include data elements from the first event data 104A and from the second event data 104B. In some examples, the context collection format for the composition event data 604 can include a first branch of data elements extracted from the first event data 104A, and include a second branch of data elements extracted from the second event data 104B. Accordingly, while the first event data 104A and the second event data 104B may be formatted according to a first context collection format, or according to different context collection formats, the composition event data 604 can be generated based on another context collection format that is different from the context collection formats of the first event data 122A and the second event data 122B, but identifies at least a subset of data elements from each of the first event data 104A and the second event data 104B.

In some examples, new composition event data 604 created by a composition operation 602 can be added to an event stream as event data 104, such as the same and/or a different event stream that contained original event data 104 used by the composition operation 602. Accordingly, other refinement operations 502 and/or composition operations 602 can operate on the original event data 104 and/or the new composition event data 604 from the event stream.

A composition operation 602 can be associated with an expected temporally ordered arrival of two pieces of event data 104. For example, the composition operation 602 shown in FIG. 6 can apply when first event data 104A arrives at a first point in time and second event data 104B arrives at a later second point in time. Because the first event data 104A may arrive before the second event data 104B, a rally point 606 can be created and stored when the first event data 104A arrives. The rally point 606 can then be used if and when second event data 104B also associated with the rally point 606 arrives at a later point in time. For example, a composition operation 602 can be defined to create new composition event data 604 from a child process and its parent process, if the parent process executed a command line. In this example, a rally point 606 associated with a first process can be created and stored when first event data 104A indicates that the first process runs a command line. At a later point, new event data 104 may indicate that a second process, with an unrelated parent process different from the first process, is executing. In this situation, the compute engine 136 can determine that a stored rally point 606 associated with the composition does not exist for the unrelated parent process, and not generate new composition event data 604 via the composition operation 602. However, if further event data 104 indicates that a third process, a child process of the first process, has launched, the compute engine 136 would find the stored rally point 606 associated with the first process and generate the new composition event data 604 via the composition operation 602 using the rally point 606 and the new event data 104 about the third process.

In particular, a rally point 606 can store data extracted and/or derived from first event data 104. The rally point 606 may include pairs and/or tuples of information about the first event data 104 and/or associated processes. For example, when the first event data 104A is associated with a child process spawned by a parent process, the data stored in association with a rally point 606 can be based on a context collection format and include data about the child process as well as data about the parent process. In some examples, the data stored in association with a rally point 606 may include at least a subset of the data from the first event data 104A.

A rally point 606 can be at least temporarily stored in memory accessible to the instance of the compute engine 136, for example in local memory on a client device 104 or in cloud storage in the security network 106. The rally point 606 can be indexed in the storage based on one or more composition operations 602 that can use the rally point 606 and/or based on identities of one or more types of composition event data 604 that can be created in part based on the rally point 606.

When second event data 122B is received that is associated with the composition operation 602 and the rally point 606, the compute engine 136 can create new composition event data 604 based on A) data from the first event data 104 that has been stored in the rally point 606 and B) data from the second event data 104B. In some examples, the rally point 606, created upon the earlier arrival of the first event data 104A, can be satisfied due to the later arrival of the second event data 104, and the compute engine 136 can delete the rally point 606 or mark the rally point 606 for later deletion to clear local or cloud storage space.

In some examples, a rally point 606 that has been created and stored based on one composition operation 602 may also be used by other composition operations 602. For example, as shown in FIG. 6, a rally point 606 may be created and stored when first event data 104A is received with respect to a first composition operation 602 that expects the first event data 104A followed by second event data 104B. However, a second composition operation 602 may expect the same first event data 104A followed by another type of event data 104 that is different from the second event data 104B. In this situation, a rally point 606 that is created to include data about the first event data 104A, such as data about a child process associated with the first event data 104A and a parent process of that child process, can also be relevant to the second composition operation 602. Accordingly, the same data stored for a rally point 606 can be used for multiple composition operations 602, thereby increasing efficiency and reducing duplication of data stored in local or cloud storage space.

In some examples, the compute engine 136 can track reference counts of rally points 606 based on how many composition operations 602 are waiting to use those rally points 606. For instance, in the example discussed above, a rally point 606 that is generated when first event data 104A arrives may have a reference count of two when the first composition operation 602 is waiting for the second event data 104B to arrive and the second composition operation 602 is waiting for another type of event data 104 to arrive. In this example, if the second event data 104B arrives and the first composition operation 602 uses data stored in the rally point 606 to help create new composition event data 604, the reference count of the rally point 606 can be decremented from two to one. If the other type of event data 104 expected by the second composition operation 602 arrives later, the second composition operation 602 can also use the data stored in the rally point 606 to help create composition event data 604, and the reference count of the rally point 606 can be decremented to zero. When the reference count reaches zero, the compute engine 136 can delete the rally point 606 or mark the rally point 606 for later deletion to clear local or cloud storage space.

In some examples, a rally point 606 can be created with a lifetime value. In some cases, first event data 104A expected by a composition operation 602 may arrive such that a rally point 606 is created. However, second event data 104A expected by the composition operation 602 may never arrive, or may not arrive within a timeframe that is relevant to the composition operation 602. Accordingly, if a rally point 606 is stored for longer than its lifetime value, the compute engine 136 can delete the rally point 606 or mark the rally point 606 for later deletion to clear local or cloud storage space. Additionally, in some examples, a rally point 606 may be stored while a certain process is running, and be deleted when that process terminates. For example, a rally point 606 may be created and stored when a first process executes a command line, but the rally point 606 may be deleted when the first process terminates. However, in other examples, a rally point 606 associated with a process may continue to be stored after the associated process terminates, for example based on reference counts, a lifetime value, or other conditions as described above.

In some situations, a composition operation 602 that expects first event data 104A followed by second event data 104B may receive two or more instances of the first event data 104A before receiving any instances of the second event data 104B. Accordingly, in some examples, a rally point 606 can have a queue of event data 104 that includes data taken from one or more instances of the first event data 104A. When an instance of the second event data 104B arrives, the compute engine 136 can remove data from the queue of the rally point 606 about one instance of the first event data 104A and use that data to create composition event data 604 along with data taken from the instance of the second event data 104B. Data can be added and removed from the queue of a rally point 606 as instances of the first event data 104A and/or second event data 104B arrive. In some examples, when the queue of a rally point 606 is empty, the compute engine 136 can delete the rally point 606 or mark the rally point 606 for later deletion to clear local or cloud storage space.

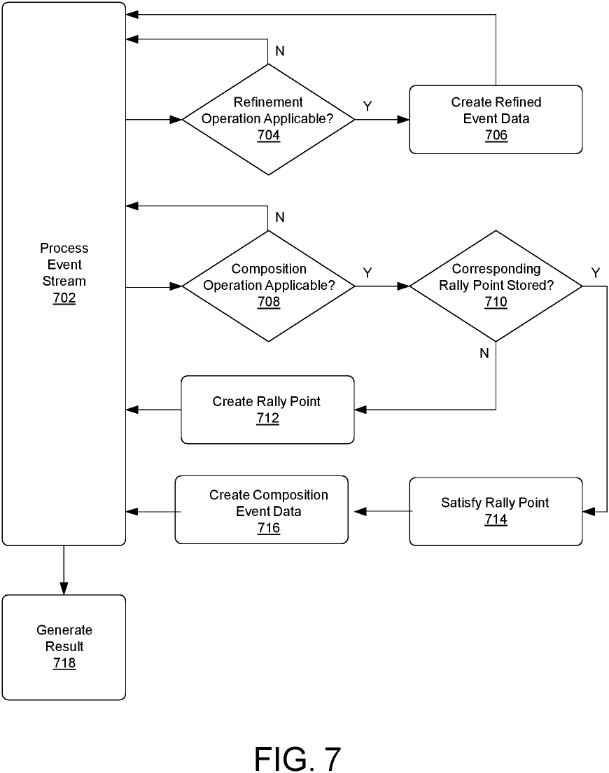

FIG. 7 depicts a flowchart of example operations that can be performed by an instance of the compute engine 136 in the distributed security system 100. At block 702, the compute engine 136 can process an event stream of event data 104. The event data 104 may have originated from an event detector of a sensor 120 that initially detected or observed the occurrence of an event on a computing device 106, and/or may be event data 104 that has been produced using refinement operations 502 and/or composition operations 602 by the compute engine 136 or a different instance of the compute engine 136.

At block 704, the compute engine 136 can determine whether a refinement operation 502 applies to event data 104 in the event stream. The event data 104 may be formatted according to a context collection format, and accordingly contain data elements or other information according to an ontological definition of the context collection format. A refinement operation 502 may be associated with filter criteria that indicates whether information in the event data 104 is associated with the refinement operation 502. If information in the event data 104 meets the filter criteria, at block 706 the compute engine 136 can generate refined event data 504 that includes a filtered subset of the data elements from the event data 104. The compute engine 136 can add the refined event data 504 to the event stream and return to block 702 so that the refined event data 504 can potentially be processed by other refinement operations 502 and/or composition operations 602.

At block 708, the compute engine 136 can determine if a composition operation 602 applies to event data 104 in the event stream. As discussed above with respect to FIG. 6, the compute engine 136 may have criteria indicating when a composition operation 602 applies to event data 104. For example, the criteria may indicate that the composition operation 602 applies when event data 104 associated with a child process of a certain parent process is received, and/or that the composition operation 602 expects first event data 104 of a child process of the parent process to be received followed by second event data 104 of a child process of the parent process. If a composition operation 602 is found to apply to event data 104 at block 708, the compute engine 136 can move to block 710.

At block 710, the compute engine 136 can determine if a rally point 606 has been generated in association with the event data 104. If no rally point 606 has yet been generated in association with the event data 104, for example if the event data 104 is the first event data 104A as shown in FIG. 6, the compute engine 136 can create a rally point 606 at block 712 to store at least some portion of the event data 104, and the compute engine 136 can return to processing the event stream at block 702.

However, if at block 710 the compute engine 136 determines that a rally point 606 associated with the event data 104 has already been created and stored, for example if the event data 104 is the second event data 104B shown in FIG. 6 and a rally point 606 was previously generated based on earlier receipt of the first event data 104A shown in FIG. 6, the rally point 606 can be satisfied at block 714. The compute engine 136 can satisfy the rally point at block 714 by extracting data from the rally point 606 about other previously received event data 104, and in some examples by decrementing a reference count, removing data from a queue, and/or deleting the rally point 606 or marking the rally point 606 for later deletion. At block 716, the compute engine 136 can use the data extracted from the rally point 606 that had been taken from earlier event data 104, along with data from the newly received event data 104, to generate new composition event data 604. The compute engine 136 can add the composition event data 604 to the event stream and return to block 702 so that the composition event data 604 can potentially be processed by refinement operations 502 and/or other composition operations 602.

At block 718, the compute engine 136 can generate a result from event data 104 in the event stream. For example, if the event stream includes, before or after refinement operations 502 and/or composition operations 602, event data 104 indicating that one or more events occurred that match a behavior pattern, the compute engine 136 can generate and output a result indicating that there is a match with the behavior pattern. In some examples, the result can itself be new event data 104 specifying that a behavior pattern has been matched.

For example, if event data 104 in an event stream originally indicates that two processes were initiated, refinement operations 502 may have generated refined event data 504 indicating that those processes include a web browser parent process that spawned a notepad child process. The refined event data 104 may be reprocessed as part of the event stream by a composition operation 602 that looks for event data 104 associated with child processes spawned by web browser parent process. In this example, the composition operation 602 can generate composition event data 604 that directly indicates that event data 104 associated with one or more child processes spawned by the same parent web browser process has been found in the event stream. That new composition event data 604 generated by the composition operation may be a result indicating that there has been a match with a behavior pattern associated with a web browser parent process spawning both a child notepad process.

In some examples, when a result indicates a match with a behavior pattern, the compute engine 136, or another component of the distributed security system 100, can take action to nullify a security threat associated with the behavior pattern. For instance, a local security agent (i.e., sensor) 108 can block events associated with malware or cause the malware to be terminated. However, in other examples, when a result indicates a match with a behavior pattern, the compute engine 136 or another component of the distributed security system 100 can alert users, send notifications, and/or take other actions without directly attempting to nullify a security threat. In some examples, the distributed security system 100 can allow users to define how the distributed security system 100 responds when a result indicates a match with a behavior pattern. In situations in which event data 104 has not matched a behavior pattern, the result generated at block 718 can be an output of the processed event stream to another element of the distributed security system 100, such as a security network and/or to another instance of the compute engine 136.

As shown in FIG. 7 a compute engine 136 can process event data in an event stream 104 using one or more refinement operations 502 and/or one or more composition operations 602 in any order and/or in parallel. Accordingly, the order of the refinement operation 502 and the composition operation 602 depicted in FIG. 7 is not intended to be limiting. For instance, as discussed above, new event data 104 produced by refinement operations 502 and/or composition operations 602 can be placed into an event stream to be processed by refinement operations 502 and/or composition operations 602 at the same instance of the compute engine 136, and/or be placed into an event stream for another instance of the compute engine 136 for additional and/or parallel processing.

### Query Manager and Compute Engine Combined

In some embodiments of event query host 102, multiple query execution engines may be concurrently deployed, and operating independently with respect to each other. The query execution engines may be homogenous, heterogeneous, and/or complementary in terms of their functionality in executing query instances or portions thereof. In some examples, the event query host 102 includes at least one query manager 128 and at least one compute engine 136. The query manager 128, as discussed above, may be preferred, in some examples, for performing retroactive graph searches and traversals of event data already added to the event graph, whereas the compute engine 136, as discussed above, may be preferred, in some examples, for performing forward looking searches that proceed, step by step, as each piece of event data from an event stream 104 arrives at the event query host 102.

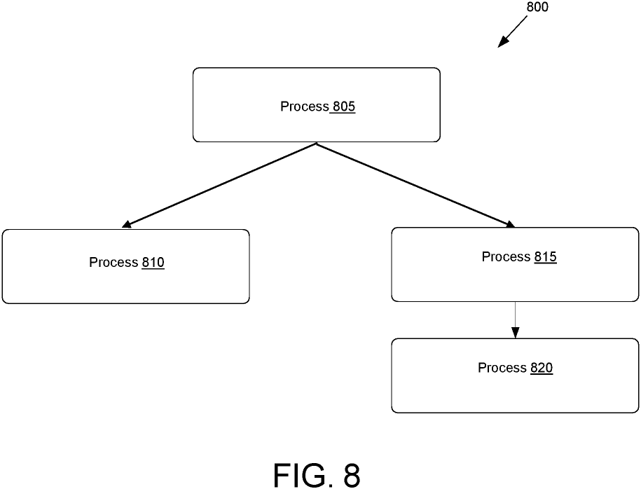

For example, with reference to event graph 800 depicted in FIG. 8, many graph queries are similarly shaped, where there is a first executing process or event depicted at node or vertex 805 that spawns or launches additional executing processes or events depicted at vertices 810 and 815, and at least one of the spawned processes, for example, the process depicted at vertex 815, launches yet another process or event depicted at vertex 820. Whether query manager 128 or compute engine 136 is better optimized to query this event graph depends on event graph details such as which event in the graph is the trigger event, where is that event located in the graph, and what is the frequency of occurrence of that event in the graph. Generally speaking, the less, or least, frequently occurring event in the graph is preferred as the trigger event. If that event happens to be the process at vertex 820, in some examples, query manager 128 is the preferred query execution engine to search for the trigger event because it efficiently performs graph traversals of event data already in the graph. If, on the other hand, the least frequently occurring event that is selected as the trigger event is the process depicted at vertex 805, in some examples, compute engine 136 is the preferred query execution engine to search for the trigger event, given the use of rally points in the compute engine model as described above, and use of the compute engine avoids the partial results and rescheduling that would be involved if the query manager were to search for that trigger event. In some instances, both query execution engines may be used to query the event graph, as for example, when that event 815 is deemed the least frequently occurring event in the event graph query and is selected as the trigger event. In this case, the query manager 128 may execute a query instance based on event 815 as the trigger event, and once the query manager 128 completes its portion of the query instance, its pass the results to the compute engine 136 to execute the remainder of the query instance using the same event as its trigger event.

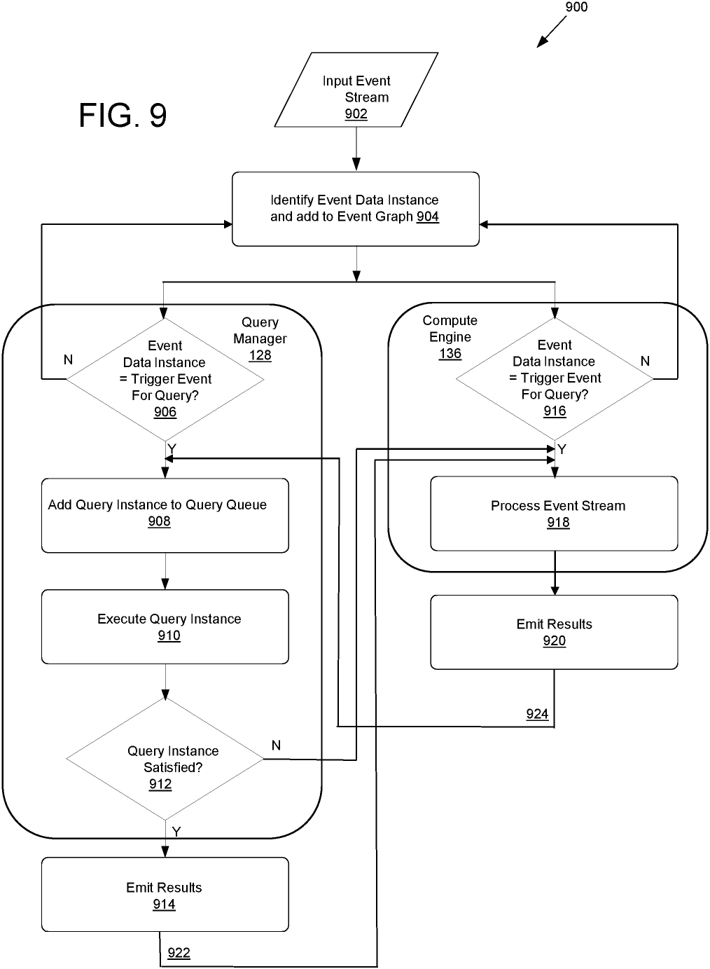

FIG. 9 is an example process 900 for the operation of the event query host 102 with multiple query execution engines, namely, query manager 128 and compute engine 136. In the example process 900, the event graph 108 may be modified, and query instances added to the query queue 114, substantially in real-time based on the event stream 104. The example process 900 shown in FIG. 9 may be performed by a computing system that executes the event processor 122, the query manager 128, and the compute engine 136, as part of the event query host 102, such as the computing system shown and described with respect to FIG. 9.

At block 902, an input event stream 104 is received that can include event data sent to the security system by local sensors on one or more computing devices. The local sensors may send the event data to the security system over temporary or persistent connections. A termination service or process of the security system (not shown) can receive event data transmitted by multiple sensors, and can provide the collected event data to a resequencer as the input event stream 902, as further described in incorporated by reference U.S. Pat. Application No. 17/325,097, entitled “Real-Time Streaming Graph Queries” .

The event data in the input event stream 902 may be in a random or pseudorandom order when it is received. For example, event data for different events may arrive at the resequencer in the input event stream 902 in any order, without regard for when the events occurred on computing devices. As another example, event data from local sensors on different computing devices may be mixed together within the input event stream 902 when they are received, without being sorted based on sensor identifiers. However, the resequencer can perform various operations to sort and route the event data to the event query host, or different event query hosts be associated with different shards within the security system. Each shard can be a distinct instance that includes a distinct event query host. Each distinct event query host can also locally store at least one event graph and locally execute queries 110 against the locally-stored event graph.

At block 904, the event processor 122 can identify an event data instance. For example, the event processor 122 may identify an event data instance within the event stream 104 received by the event query host 102. As discussed above, the event stream 104 can be a data stream that indicates events, detected by the sensor 120, that have occurred on the computing device 106. Accordingly, at block 904, the event processor 122 can identify an individual instance of event data indicated by information within the event stream 104. In some examples, the event processor 122 may receive event streams, associated with multiple computing devices and sensors, within a shard topic, or receive even streams associated with events detected by Cloud Security Posture Management (CSPM) security tools that have occurred in a cloud services computing environment of the security system customer, as discussed above.

The event processor 122 may accordingly identify an event data instance, associated with one of those computing devices at block 904. Further at block 904, the event processor 122 can add one or more entities to the event graph 108 that are associated with the identified event data instance. For example, the event processor 122 can add a vertex to the event graph 108 that represents the event data instance, and/or add an edge to the event graph 108 that represents a relationship between events represented vertices 202 in the event graph 108. The event processor 122 may add an entity to the event graph 108 at block 904 by adding an entry to a database.

At block 906, the query manager 128 (denoted by dotted line in FIG. 9) can determine whether the event data instance is a trigger event associated with a query to be executed by the query manager 128. As discussed above, the event query host 102 can be configured with query definitions 124 for one or more queries 110, including indications of trigger events 126 for the queries 110 and indications of query execution engines 138. The query manager 128 can accordingly use the query definitions 124 to determine whether the event data instance, identified at block 904, matches a trigger event for a query, to be executed by query manager 128. A trigger event for a query may be associated with an event type, and/or one of more filters, as discussed above.

If the event data instance identified at block 904 does not match a trigger event for any of the queries (Block 906 - No) to be executed by query manager 128, the query manager 128 can return to block 904, after the event processor 122 adds a representation of the event data instance to the event graph 108, and process a subsequent instance of event data within the event stream 104. However, if the event data instance identified at block 904 does match a trigger event for a query (Block 906 - Yes), the query manager 128 can add a corresponding query instance to the query queue 114 to be processed by query manager 128 at Block 908. The query manager 128 may add the new query instance to the query queue 114 with a scheduled execution time selected based on a default scheduling configuration, based on a rescheduling scheme associated with the query, or based on any other scheduling configuration. The query manager 128 can then return control to event processor 122 at block 904, which can process a subsequent instance of event data within the event stream 104.

Overall, as shown in FIG. 9, the event processor 122 may add a representation of each identified event data instance to the event graph, substantially in real-time as the event data is received and processed by the event processor 122. The query manager 128 may also, substantially in real-time as the event data is received and processed by the event processor 122, add query instances 112 to the query queue 114 that are associated with event data instances that correspond to trigger events for queries 110 to be executed by query manager 128, but avoid adding query instances 112 to the query queue 114 that are associated with instances of event data that do not correspond to trigger events 126 for queries 110 to be executed by query manager 128. Accordingly, the query instances 112 that are scheduled within the query queue 114 by the query manager 128 at block 908 can be likely to be at least partially satisfied when executed by the query manager 128, because event data corresponding to trigger events 126 for those query instances 112 was added to the event graph 108 at block 904.

At block 910, the query manager 128 may maintain the query queue 114. As discussed above, the query queue 114 may be an ordered list or database of query instances 112 sorted by scheduled execution times 116. For example, the highest-priority query instance in the query queue 114 may be the query instance with the next scheduled execution time. Further at block 910, the query manager 128 can determine if it is the scheduled execution time for a query instance in the query queue 114. For example, if it is not yet the scheduled execution time for the highest-priority query instance in the query queue 114, the query manager 128 can continue to maintain the query queue 114 until the scheduled execution time for the highest-priority query instance in the query queue 114. Finally, at block 910, at the scheduled execution time for a query instance in the query queue, the query manager 128 may execute the query instance by traversing the event graph 108 and searching for one or more entities in the event graph 108 that correspond with the query criteria 130 of the query instance. The query criteria 130 may be a pattern of one or more events. As a non- limiting example, the query manager 128 can use graph isomorphism principles and/or perform graph traversal operations to search for one or more sub-graphs, within the event graph 108, that match a graph of events associated with the query instance.

In some examples, if the query instance is associated with a partial query state that indicates portions of the query criteria 130 previously found in the event graph 108, the query manager 128 may avoid searching the event graph 108 for the previously found portions of the query criteria 130. The query manager 128 may instead attempt to locate other portions of the query criteria 130 that have not yet been found in the event graph 108, but would satisfy the query criteria 130 in combination with the partial query state.

At Block 912, the query manager 128 can determine if the query instance has been satisfied. For example, query manager 128 can determine if all of the elements of the query criteria 130 associated with the query instance have been found in the event graph 108, either based on the search performed at block 910 and/or in combination with a prior partial query state associated with the query instance. If all of the elements of the query criteria 130 associated with the query instance have been found in the event graph 108, the query manager 128 can determine if the query instance has been satisfied (Block 912 - Yes) and can output corresponding query results 118 at block 914.

However, if the query manager 128 determines that the query instance has not yet been satisfied (Block 912 - No), the query manager 128 may store the partial query state associated with the query instance. For example, if one or more portions of the query criteria 130 were found in the event graph 108 during the search performed at block 910, the query manager 128 may store those portions as a new partial query state associated with the query instance, or add the newly located portions to a previously-stored partial query state associated with the query instance. Alternatively, or additionally, the query manager 128 may forward the partial query state associated with the query instance to compute engine 136 for further processing at block 918. For example, compute engine (or another engine, for that matter) may have better/faster capabilities for evaluating fields of events and vertexes than query manager 128, and so query manager 128 may hand off or transfer evaluations to compute engine 136 for processing. As discussed below, compute engine 136 may perform the evaluation and return a result to query manager 128, whereupon query manager 128 may accept the result and return the query instance to the query queue 114 with a scheduled execution time selected based on a default scheduling configuration, based on a rescheduling scheme associated with the query, or based on any other scheduling configuration. The query manager 128 can then return control to event processor 122 at block 904, which can process a subsequent instance of event data within the event stream 104.

Going back to block 904, the event processor 122 can identify an event data instance based on information within the event stream 104. The event processor 122 may accordingly identify an event data instance and add one or more entities to the event graph 108 that are associated with the identified event data instance.

Additionally, the query manager 128 may forward the emitted results 914 associated with the query instance to compute engine 136 for further processing as indicated by the flow path 922 in FIG. 9. For example, compute engine (or another engine, for that matter) may have capabilities for further evaluating the emitted results 914, and so query manager 128 may transmit the results 914 to compute engine 136 for processing. Compute engine 136 may perform an evaluation upon receiving the results and emit its own results 920. Compute engine 136 may, in some instances, return those results 920 back to query manager 128, as indicated by flow path 924, whereupon query manager 128 may accept the compute engine’s results and return the query instance to the query queue 114 with a scheduled execution time selected based on a default scheduling configuration, based on a rescheduling scheme associated with the query, or based on any other scheduling configuration. The query manager 128 can then return control to event processor 122 at block 904, which can process a subsequent instance of event data within the event stream 104.

Concurrently with block 906, at block 916 the compute engine 136 (denoted by dotted line in FIG. 9) can determine whether the event data instance is a trigger event associated with a query to be executed by the compute engine 136. As discussed above, the event query host 102 can be configured with query definitions 124 for one or more queries 110, including indications of trigger events 126 for the queries 110 and indications of query execution engines 138. The compute engine 136 can accordingly use the query definitions 124 to determine whether the event data instance, identified at block 904, matches a trigger event for a query, to be executed by compute engine 136. A trigger event for a query may be associated with an event type, and/or one of more filters, as discussed above.

If the event data instance identified at block 904 does not match a trigger event for any of the queries (Block 916 - No) to be executed by compute engine 136, the compute engine 136 can return to block 904, after the event processor 122 adds a representation of the event data instance to the event graph 108, and process a subsequent instance of event data within the event stream 104. However, if the event data instance identified at block 904 does match a trigger event for a query (Block 916 - Yes), the compute engine 136 can process the event data as part of the event stream at Block 918, according to the process described above with reference to FIGS. 5-7, and generate a result at Block 920, for example, new event data created by a refinement operation, creation of a rally point, or creation of composition event data in satisfaction of a rally point. Recall from the discussion above with reference to FIG. 1 that a query definition 124 for a query 110 may identify instances of multiple query execution engines (e.g., query manager 128 and compute engine 136) that, when the associated trigger event 126 for the query is detected in the event stream 104, the respective query execution engines execute at least a portion of an instance of the query. For example, the instance of query execution engine 138C associated with query 110C may be both query manager 128 and compute engine 136. Thus, query manager 128 can determine a query instance has been satisfied (Block 912 - Yes) and can output corresponding query results 118 at block 914 and compute engine 136 can also determine the event data instance identified at block 904 matches a trigger event for a query (Block 916 - Yes) and process the event data as part of the event stream at Block 918 and generate a result at Block 920. The results emitted at Blocks 914 and 920 may be combined, in some embodiments.

Additionally, the compute engine 136 may forward the emitted results 920 associated with the query instance to query manager 128 for further processing as indicated by the flow path 924 in FIG. 9. For example, query manager 128 (or another engine, for that matter) may have capabilities for further evaluating the emitted results 920, and so compute engine 136 may transmit the results 920 to query manager 128 for processing, whereupon a query instance is added to query queue 908. Query manager 128 may execute the query instance 910 and emit its own results 914. Query manager 128 may, in some instances, return the results to compute engine 136, as indicated by flow path 922, whereupon compute engine 136 may accept the query manager’s results. The compute engine can then return control to event processor 122 at block 904, which can process a subsequent instance of event data within the event stream 104.

FIG. 10 shows an example system architecture 1000 for a computing system 1002 associated with the event query host 102 described herein. The computing system 1002 can be a server, computer, or other type of computing device that executes one or more event query hosts. In some examples, the event query host 102 can be executed by a dedicated computing system 1002. In other examples, the computing system 1002 can execute one or more event query hosts via virtual machines or other virtualized instances. For instance, the computing system 1002 may execute multiple event query hosts in parallel, using different virtual machines, parallel threads, or other parallelization techniques.

The computing system 1002 can include memory 1004. In various examples, the memory 1004 can include system memory, which may be volatile (such as RAM), non-volatile (such as ROM, flash memory, non-volatile memory express (NVMe), etc.) or some combination of the two. The memory 1004 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 1002. Any such non- transitory computer-readable media may be part of the computing system 1002.

The memory 1004 can store data associated with the event graph 108, the query definitions 124, the query queue 114, the event processor 122, the query manager 128, the compute engine 136, and/or any other element of the event query host. As discussed above, the event graph 108 may be stored locally in the memory 1004 such that the event processor 122 and/or the query manager 128 and/or compute engine 136 can locally interact with the event graph 108. The memory 1004 can also store other modules and data 1006. The modules and data 1006 can include any other modules and/or data that can be utilized by the computing system 1002 to perform or enable performing the actions described herein. Such other modules and data can include a platform, operating system, and applications, and data utilized by the platform, operating system, and applications.

By way of a non-limiting example, the computing system 1002 that executes the event query host 102 may have non-volatile memory, such as an NVMe disk configured to store the event graph 108, the query definitions 124, the query queue 114, and/or other data associated with the event query host. The computing system 1002 that executes the event query host 102 may also have volatile memory, such as synchronous dynamic RAM (SDRAM), double data rate (DDR) SDRAM, DDR2 SDRAM, DDR3 SDRAM, or DD4 SDRAM.

The computing system 1002 can also have one or more processors 1008. In various examples, each of the processors 1008 can be a central processing unit (CPU), a graphics processing unit (GPU), both a CPU and a GPU, or any other type of processing unit. For example, each the processors 1008 may be a 10-core CPU, or any other type of processor. Each of the one or more processors 1008 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processors 1008 may also be responsible for executing computer applications stored in the memory 1004, which can be associated with types of volatile and/or nonvolatile memory.

The computing system 1002 can also have one or more communication interfaces 1010. The communication interfaces 1010 can include transceivers, modems, interfaces, antennas, telephone connections, and/or other components that can transmit and/or receive data over networks, telephone lines, or other connections. For example, the communication interfaces 1010 can include one or more network cards that can be used to receive the event stream 104 and/or output query results 118.

In some examples, the computing system 1002 can also have one or more input devices 1012, such as a keyboard, a mouse, a touch-sensitive display, voice input device, etc., and/or one or more output devices 1014 such as a display, speakers, a printer, etc. These devices are well known in the art and need not be discussed at length here.

The computing system 1012 may also include a drive unit 1016 including a machine readable medium 1018. The machine readable medium 1018 can store one or more sets of instructions, such as software or firmware, that embodies any one or more of the methodologies or functions described herein. The instructions can also reside, completely or at least partially, within the memory 1004, processor(s) 1008, and/or communication interface(s) 1010 during execution thereof by the computing system 1002. The memory 1004 and the processor(s) 1008 also can constitute machine readable media 1018.

Although the subj ect matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
receiving, at one or more processors of a computing system, an event stream comprising event data associated with occurrences of events on one or more computing devices;
forwarding, by the one or more processors, the event data to a first query engine and a second query engine;
determining, by the first query engine, based on a set of query definitions, that the event data forwarded by the one or more processors is associated with a first query to be executed by the first query engine;
executing, by the first query engine, a first query instance associated with the first query;
determining, by the second query engine, based on the set of query definitions, that the event data forwarded by the one or more processors is associated with a second query to be executed by the second query engine; and
executing, by the second query engine, a second query instance associated with the second query.

2. The computer-implemented method of claim 1, further comprising incorporating, by the one or more processors, the event data into an event graph; and
wherein executing, by the first query engine, the first query instance associated with the first query, comprises identifying an event pattern associated with the query, and searching the event graph for a sub-graph that matches the event pattern.

3. The computer-implemented method of claim 1, wherein executing, by the second query engine, a second query instance associated with the second query, comprises:
generating, by the second query engine using at least one of one or more refinement operations or one or more composition operations, new events based on the event data in the event stream; and
adding, by the second query engine, the new events to the event stream.

4. The computer-implemented method of claim 1, further comprising:
generating, by the first query engine, query results associated with the execution of the first query instance;
forwarding, by the first query engine, the query results associated with the execution of the first query instance to the second query instance; and
wherein executing, by the second query engine, the second query instance associated with the second query comprises executing, by the second query engine, the second query instance associated with the second query using the query results associated with the execution of the first query instance.

5. The computer-implemented method of claim 1, further comprising:
receiving, at a user or programmatic input interface of the computing system, a set of query definitions associated with queries, wherein each query definition identifies:
a trigger event with which a query is associated that, when detected in an event stream, causes adding an instance of the query to a query queue for execution, and
which of a first query engine and a second query engine to execute the instance of the query in response to detecting the trigger event in the event stream; and
deploying, by the one more processors, the set of query definitions to each of the first and second query engines.

6. The computer-implemented method of claim 5, further comprising receiving, at the user or programmatic input interface of the computing system input identifying the trigger event based on a frequency, or a location, of the trigger event in an event pattern in the event stream.

7. The computer-implemented method of claim 5, wherein receiving, at a user or programmatic input interface of the computing system, a set of query definitions associated with queries comprises receiving in a first language, at the user or programmatic input interface of the computing system, the set of query definitions associated with queries;
the computer implemented method further comprising translating, by the one or more processors, the query definitions into a second language for execution by the first query engine and into a third language for execution by the second query engine; and
wherein deploying, by the one or more processors, the set of query definitions to each of the first and second query engines comprises deploying, by the one or more processors, the set of query definitions to each of the first and second query engines as respectively translated into the second and third languages.

8. A computing system, comprising:
one or more processors;
memory storing computer-executable instructions that, when executed by the one or more processors, cause the one or more processors to perform operations comprising:
receiving an event stream comprising event data associated with occurrences of events on one or more computing devices;
forwarding the event data to a first query engine and a second query engine;
determining, by the first query engine, based on a set of query definitions, that the forwarded event data is associated with a first query to be executed by the first query engine;
executing, by the first query engine, the first query instance associated with the first query;
determining, by the second query engine, based on the set of query definitions, that the forwarded event data is associated with a second query to be executed by the second query engine; and
executing, by the second query engine, a second query instance associated with the second query.

9. The computing system of claim 8, wherein the operations further comprise incorporating the event data into an event graph; and
wherein executing, by the first query engine, the first query instance associated with the first query, comprises identifying an event pattern associated with the query, and searching the event graph for a sub-graph that matches the event pattern.

10. The computing system of claim 8, wherein executing, by the second query engine, a second query instance associated with the second query, comprises:
generating, by the second query engine using at least one of one or more refinement operations or one or more composition operations, new events based on the event data in the event stream; and
adding, by the second query engine, the new events to the event stream.

11. The computing system of claim 8, wherein the operations further comprise:
generating, by the first query engine, query results associated with the execution of the first query instance;
forwarding, by the first query engine, the query results associated with the execution of the first query instance to the second query instance; and
wherein executing, by the second query engine, the second query instance associated with the second query comprises executing, by the second query engine, the second query instance associated with the second query using the query results associated with the execution of the first query instance.

12. The computing system of claim 8, wherein the operations further comprise:
receiving a set of query definitions associated with queries, wherein each query definition identifies:
a trigger event with which a query is associated that, when detected in an event stream, causes adding an instance of the query to a query queue for execution, and
which of a first query engine and a second query engine to execute the instance of the query in response to detecting the trigger event in the event stream; and
deploying the set of query definitions to each of the first and second query engines.

13. The computing system of claim 12, wherein the operations further comprise receiving input identifying the trigger event based on a frequency, or a location, of the trigger event in an event pattern in the event stream.

14. The computing system of claim 12, wherein receiving the set of query definitions associated with queries comprises receiving in a first language the set of query definitions associated with queries;
wherein the operations further comprise translating the query definitions into a second language for execution by the first query engine and into a third language for execution by the second query engine; and
wherein deploying the set of query definitions to each of the first and second query engines comprises deploying the set of query definitions to each of the first and second query engines as respectively translated into the second and third languages.

15. One or more non-transitory computer-readable media storing computer-executable instructions for an event query host that, when executed by one or more processors, cause the one or more processors to perform operations comprising:
receiving an event stream comprising event data associated with occurrences of events on one or more computing devices;
forwarding the event data to a first query engine and a second query engine;
determining, by the first query engine, based on a set of query definitions, that the forwarded event data is associated with a first query to be executed by the first query engine;
executing, by the first query engine, the first query instance associated with the first query;
determining, by the second query engine, based on the set of query definitions, that the forwarded event data is associated with a second query to be executed by the second query engine; and
executing, by the second query engine, a second query instance associated with the second query.

16. The one or more non-transitory computer-readable media of claim 15, wherein the operations further comprise incorporating the event data into an event graph; and
wherein executing, by the first query engine, the first query instance associated with the first query, comprises identifying an event pattern associated with the query, and searching the event graph for a sub-graph that matches the event pattern.

17. The one or more non-transitory computer-readable media of claim 15, wherein executing, by the second query engine, a second query instance associated with the second query, comprises:
generating, by the second query engine using at least one of one or more refinement operations or one or more composition operations, new events based on the event data in the event stream; and
adding, by the second query engine, the new events to the event stream.

18. The one or more non-transitory computer-readable media of claim 15, wherein the operations further comprise:
generating, by the first query engine, query results associated with the execution of the first query instance;
forwarding, by the first query engine, the query results associated with the execution of the first query instance to the second query instance; and
wherein executing, by the second query engine, the second query instance associated with the second query comprises executing, by the second query engine, the second query instance associated with the second query using the query results associated with the execution of the first query instance.

19. The one or more non-transitory computer-readable media of claim 15, wherein the operations further comprise:
receiving a set of query definitions associated with queries, wherein each query definition identifies:
a trigger event with which a query is associated that, when detected in an event stream, causes adding an instance of the query to a query queue for execution, and
which of a first query engine and a second query engine to execute the instance of the query in response to detecting the trigger event in the event stream; and
deploying the set of query definitions to each of the first and second query engines.

20. The one or more non-transitory computer-readable media of claim 19, wherein the operations further comprise receiving input identifying the trigger event based on a frequency, or a location, of the trigger event in an event pattern in the event stream.

21. The one or more non-transitory computer-readable media of claim 19, wherein receiving the set of query definitions associated with queries comprises receiving in a first language the set of query definitions associated with queries;
wherein the operations further comprise translating the query definitions into a second language for execution by the first query engine and into a third language for execution by the second query engine; and
wherein deploying the set of query definitions to each of the first and second query engines comprises deploying the set of query definitions to each of the first and second query engines as respectively translated into the second and third languages.
